(19) United States
(12) Patent Application Publication
(10) Pub. No.: US 2010/0326891 A1
(43) Pub. Date: Dec. 30, 2010

(54) SEPARATION OF CARBON NANOTUBE BUNDLES VIA INTERFACIAL TRAPPING

(75) Inventors: Kai-Wei Wang, Gainesville, FL (US); Ryan David Reeves, Amherst, MA (US); Kirk Jeremy Ziegler, Gainesville, FL (US)

Correspondence Address: SALIWANCHIK LLOYD & SALIWANCHIK;A PROFESSIONAL ASSOCIATION, PO Box 142950, GAINESVILLE, FL, 32614, US

(73) Assignee: UNIVERSITY OF FLORIDA RESEARCH FOUNDATION INC., Gainesville, FL (US)

(21) Appl. No.: 12/677,850

(22) PCT Filed: Sep. 12, 2008
(86) PCT No.: PCT/US08/76272

§ 371 Date: Sep. 13, 2010

Related U.S. Application Data
(60) Provisional application No. 60/971,717, filed on Sep. 12, 2007.

(51) Int. Cl. B03B 5/00; B82B 3/00

(52) U.S. Cl. 209/132; 977/845

(57) ABSTRACT

In embodiments of the invention, bundles of carbon nanotubes are separated from individual nanotubes via interfacial trapping of bundled carbon nanotube bundles at an emulsion interface between suspension-phase and a solution-phase. The separation method comprises dispersing a mixture of individual and bundled carbon nanotubes in a solution comprising surfactant; adding at least one solvent to the surfactant solution to form a two-phase mixture; agitating the two-phase mixture to form an emulsion interface between the solution-phase and a suspension-phase, where nanotube bundles selectively segregate to the emulsion interface. Single-walled carbon nanotube suspensions exhibit strong fluorescence, which can be used to assess the degree of separation and determine if a repeated extraction of any remaining bundled carbon nanotubes remaining in the suspension-phase is desired. In another embodiment of the invention, separation of carbon nanotubes by type is carried out by interfacial trapping.

### CROSS-REFERENCE TO RELATED APPLICATIONS

The present application claims the benefit of U.S. Provisional Application Ser. No. 60/971,717, filed Sep. 12, 2007, which is hereby incorporated by reference herein in its entirety, including any figures, tables, or drawings.

### FIELD OF THE INVENTION

This invention relates generally to carbon nanotubes, and specifically to methods for separating bundled carbon nanotubes from individual nanotubes using liquid-liquid extraction methods.

### BACKGROUND OF INVENTION

Single-wall carbon nanotubes (SWNT), commonly known as “buckytubes,” have unique properties, including high strength, stiffness, thermal and electrical conductivity. SWNT are hollow, tubular fullerene molecules consisting essentially of sp²-hybridized carbon atoms typically arranged in hexagons and pentagons. Single-wall carbon nanotubes typically have diameters in the range of about 0.5 nanometers (nm) and about 3.5 nm, and lengths usually greater than about 50 nm. Background information on single-wall carbon nanotubes can be found in Yakobson et al., American Scientist, 1997, 85, 324-37 and Dresselhaus, et al., Science of Fullerenes and Carbon Nanotubes, 1996, San Diego: Academic Press, Ch. 19.

Because of their unique physical and chemical properties, SWNTs have excited researchers with regard to their potential utility in microelectronic and biomedical applications. Several methods are currently available for producing SWNTS. Unfortunately, post-production SWNTs still require separation and sorting to capture nanotubes having specific, desired properties. These separation and sorting methods are complicated by two major factors. The first complication is that nanotubes lack solubility in water and most common solvents. Many common solvents cannot offer sufficient solvation forces to suspend SWNTs yielding low degrees of solubility. These suspensions consist of many small bundles and relatively few individual SWNTs. These difficulties arise from the strong propensity of single-wall carbon nanotubes to rope together in “bundles” that are strongly held together by van der Waals forces. The bundling phenomenon aggregates different types of single-wall carbon nanotubes together in aligned bundles and holds them together with a sizable tube-to-tube binding energy of up to about 500 eV/micron.

A second complication to separation and sorting is that synthesized carbon nanotube samples generally contain random mixtures of metallic and semiconducting types of nanotubes with assorted diameters. SWNT synthesis typically results in 30-40 different (n,m) chirality types (approximately ⅓ metallic and ⅔ semiconducting). When electrically contacted while in bundled aggregates, the carbon nanotubes experience sizable perturbations from their otherwise pristine electronic structure that complicates the differentiation between different types of nanotubes.

The inability to obtain individually dispersed SWNTs has limited nanotube applications leading researchers to develop a multitude of functionalization schemes to achieve nanotube suspensions. For example, attempts to exploit the chemical diversity within mixtures of nanotubes, either through sidewall functionalization or end-group derivatization have not been successful in separating bundled nanotubes from individual nanotubes, rather, bundles of nanotubes with significantly altered electronic properties are largely produced.

The conventional method to disperse individual nanotubes in aqueous solutions is by high-shear homogenization in various surfactant solutions, ultrasonication, and ultimately ultracentrifugation to separate bundled nanotubes from individually-dispersed nanotubes. However, ultracentrifugation is an expensive and time-consuming approach to the removal of SWNT bundles most applicable to analytical scales.

The adsorption of particles at interfaces and emulsion stabilization has been known for a century, Pickering, J. Chem. Soc. Trans. 1907, 91, 2001-21. These systems have recently gained renewed interest because of their ability to self-assemble particles at the interface, to separate particles, such as ampicillin and phenylglycine crystal mixtures in water/alkanol systems, and to prepare unique porous structures. Of particular importance, these systems have demonstrated the large-scale separation of bioparticles achieving efficiencies greater than centrifugation. Free energy changes induced by changes in wetting and interfacial area are often used to describe particle adsorption from the bulk solution to the interface.

Most research on Pickering emulsions has focused on spherical particles rather than carbon nanotubes. Wang et al., Langmuir, 2003, 19, 2091 discloses SWNT-based stabilization of emulsions. Bare nanotubes were used as amphiphobic surfactants that stabilized toluene/water emulsions for months. Later, DNA-wrapped SWNTs were shown to stabilize emulsions for the synthesis of colloidal particles. Stabilized emulsions were also seen in length-based separations of functionalized SWNTs.

More recently, researchers have begun to use SWNT-based Pickering emulsions for other applications. Asuri et al., J. Am. Chem. Soc., 2006, 128, 1046-7 discloses interfacial SWNTs decreased transport limits and improved catalytic activity of two-phase reactions leading to increased bio-reactivity. Others have used polymerization reactions or nanotube interactions to prepare nanotube capsules that can be used as catalyst supports, controlled release capsules, and lubricating additives.

None of the aforementioned methods have been applied to the separation of bundled SWNTs from individual SWNTs in aqueous suspensions. In view of the foregoing, a simpler, more scalable method of separating bundled nanotubes from individual nanotubes is necessary and would be extremely useful.

### BRIEF SUMMARY

The present invention provides methods for separating carbon nanotubes. In certain embodiments, methods are provided for removing bundled nanotubes from a mixture of individual and bundled nanotubes in aqueous suspensions using interfacial trapping. In other embodiments, methods are provided for separating carbon nanotubes by type or size.

In one embodiment of the subject invention, bundled nanotubes are separated from individual, dispersed nanotubes in aqueous mixtures via two-phase extraction using, for example, toluene and Gum Arabic solutions. The separation methods of the invention are capable of treating quantities of individual and bundled nanotube mixtures in excess of one kilogram and are scalable to even larger volumes. Furthermore, the separation methods produce a population of individual carbon nanotubes of suitable purity for many applications, including further separation into populations by size or type.

For example, embodiments of the invention include the step of encouraging target nanotubes (either by size and/or type) to aggregate into bundles in solution. Such bundles of target nanotubes would then be separated from non-target individual nanotubes using the methods of the invention. According to the subject invention, the target nanotubes can be aggregated into bundles either during or following separation of bundled nanotubes from individual nanotubes.

In one related embodiment of the invention, following production of a stable suspension of individual carbon nanotubes target individual carbon nanotubes (either a specific size and/or type) are forced to aggregate by mixing with additives or reactants for separations. For example, Niyogi et al., J. Am. Chem. Soc. 2007, 129, 1898-9 has disclosed that salts can be added to SDS-suspended SWNT solutions to induce aggregation. This salt addition has been shown to induce diameter or (n,m) type selective aggregation. These aggregated nanotubes are then separated using the interfacial trapping described herein or using the separation methods described in Ziegler, International publication number WO2008/057070.

### BRIEF DESCRIPTION OF DRAWINGS

FIG. 1 is a flow diagram illustrating one embodiment of the invention for separating individual from bundled nanotubes.

FIGS. 2A and 2B are flow diagrams illustrating other embodiments of the invention for separating individual nanotubes by (n,m) type.

FIG. 3 illustrates an overall process of removing SWNT bundles from aqueous suspensions via liquid-liquid interfaces in accordance with the subject invention. FIG. 3(a) illustrates initial suspension of a mixture of individually suspended SWNTs and SWNT bundles with an organic solvent; FIG. 3(b) illustrates SWNT bundles trapped at emulsion interfaces; FIG. 3(c) illustrates the creaming and coalescence of emulsions after mixing; and FIG. 3(d) illustrates the removal of SWNT bundles from the bulk fluid.

FIG. 4 is a photographic reproduction of, left, a separatory vial showing the interface between the oil and water phases after interfacial trapping, and an optical micrograph, right, showing a stabilized toluene droplet in a continuous aqueous phase.

FIG. 5 is a photographic reproduction of a separatory funnel showing SWNT bundles trapped at emulsion interfaces.

FIG. 6 shows absorbance spectra of Gum Arabic-suspended SWNTs from an initial mass concentration of 0.03 mg/mL of raw material. The control spectrum is the sample after homogenization and sonication. This sample is then either subjected to centrifugation or an interfacial trap. Note the break in the absorbance scale.

FIG. 7 illustrates the fluorescence spectra of Gum Arabic-suspended SWNTs prepared from 6 mg of raw material with FIG. 7(a) illustrating excitation with a 660 nm laser, and FIG. 7(b) illustrating excitation with a 785 nm laser.

FIG. 8 shows (a) fluorescence spectra (Ex=662 nm), (b) absorbance spectra, and (c) Raman RBM spectra (Ex=785 nm) of Gum Arabic-suspended SWNTs for one-step and two-step interfacial trapping separations compared to ultracentrifugation. The suspensions were prepared from an initial concentration of 0.2 mg/mL raw SWNTs.

FIG. 9 illustrates the adsorption process of a nanotube at the interface of the oil and water phases in accordance with the subject invention. FIG. 9(a) illustrates the dispersal of nanotubes (individual or bundled) in an aqueous phase prior to interfacial trapping followed by the movement of nanotubes to the interface; FIG. 9(b) is a diagram showing the end of a nanotube at the interface where R is the radius of the nanotube, and θ is the contact angle measured into the water phase.

FIG. 10 illustrates the fluorescence emission intensity fluctuations at λ=1140 nm as a function of the volume ratio of toluene to the aqueous SWNT suspension. FIG. 10(a) illustrates the emission intensity for a sample prepared from 6 mg raw material; and FIG. 10(b) illustrates the emission intensity for a sample prepared from 1 mg raw material.

FIG. 11 shows optical spectra of Gum Arabic-suspended SWNTs prepared from 6 mg raw material with FIG. 11(a) illustrating absorbance spectra of Gum Arabic-suspended SWNTs and FIG. 11(b) illustrating fluorescence (Ex=660 nm) to absorbance ratio fluctuations at λ=1140 nm as a function of the volume ratio of toluene to the aqueous SWNT suspension.

### DETAILED DISCLOSURE

Embodiments of the invention are directed to methods for sorting and separating carbon nanotubes by selecting interfacial trapping in aqueous or organic suspensions. In one embodiment, the invention provides methods for sorting and separating bundled carbon nanotubes from individual nanotubes. The separation method preferentially traps carbon nanotube bundles at the interface of a two-phase mixture because of changes in free energy. Although the separation is not necessarily absolute, separation of bundles from individual carbon nanotubes occurs to a large extent. By using a suspension-phase comprising individual carbon-nanotubes as the starting mixture, a subsequent separation leads to a suspension-phase that is more highly enriched in individual nanotubes.

The subject invention can be applied to various types of carbon nanotubes including, but not limited to, single-walled carbon nanotubes (SWNTs), double walled carbon nanotubes (DWNTs), triple walled carbon nanotubes (TWNTs), few walled carbon nanotubes (FWNTs), and multi wall carbon nanotubes (MWNTs). Single-walled carbon nanotubes (SWNTs) are readily sorted and separated in accordance with an embodiment of the subject invention.

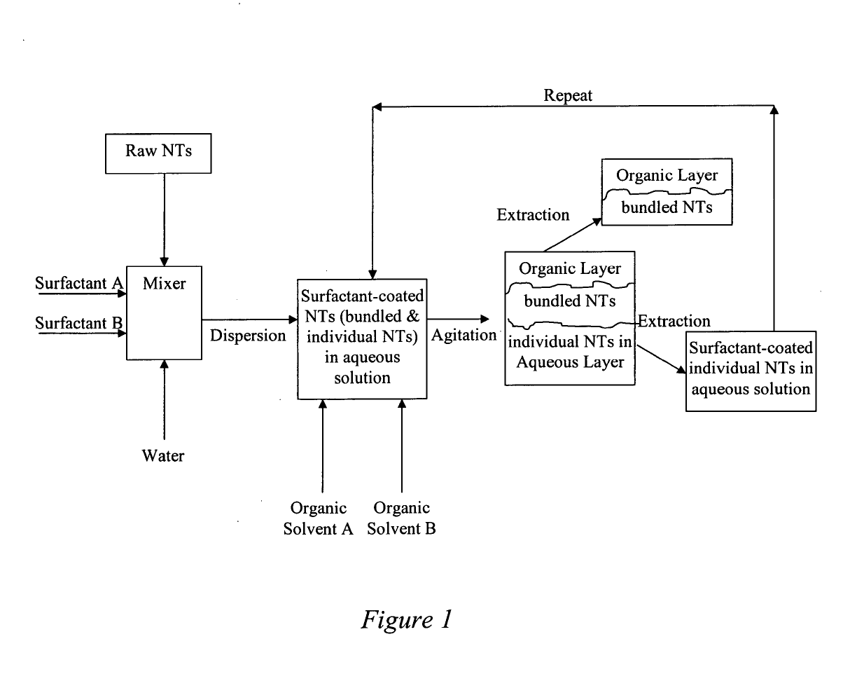

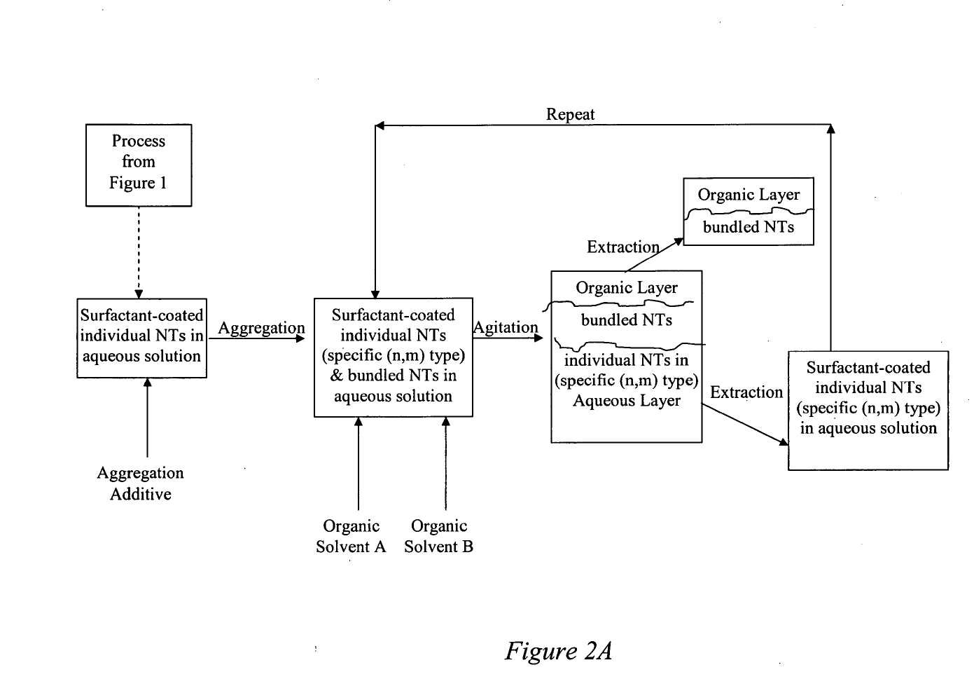

As illustrated in FIG. 1, the separation method for individual versus bundled nanotubes comprises the step of: (a) dispersing a mixture of individual and bundled carbon nanotubes in water using one or more surfactant solution; (b) adding one or more organic solvents to the resultant surfactant solution from step (a) to form a two-phase mixture; (c) agitating the two-phase mixture to form an emulsion interface between a suspension-phase, illustrated as the aqueous layer and an organic layer, wherein agitating the two-phase mixture effects the preferential adsorption of nanotube bundles at the emulsion interface.

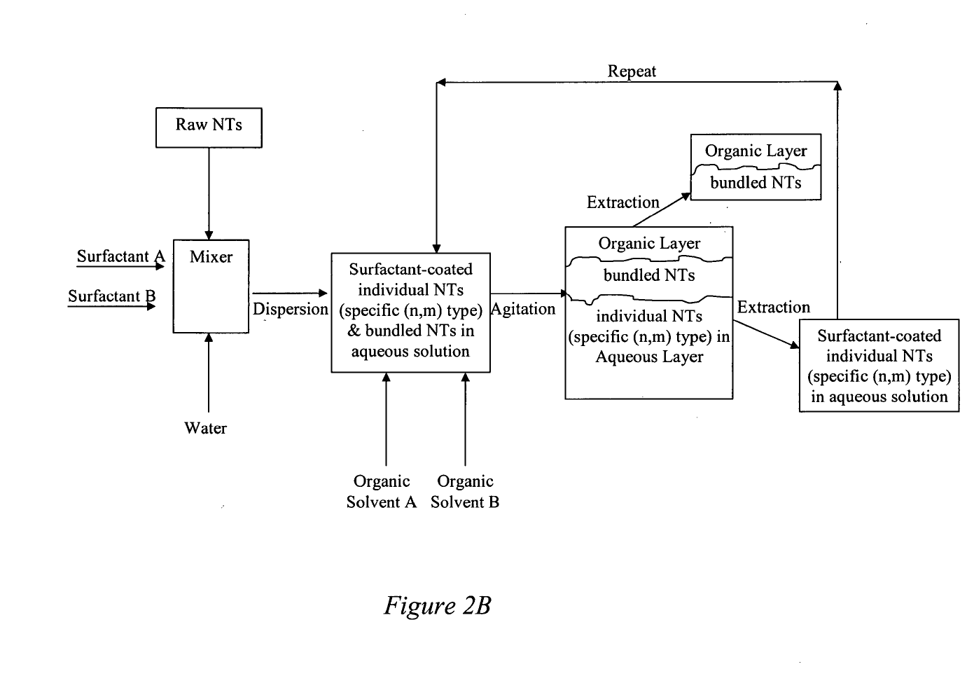

In a related embodiment, the invention provides methods for sorting and separating carbon nanotubes by size and/or (n,m) type, simultaneous to or following separation of carbon nanotubes into bundled and individual nanotubes. In these embodiments, separation of carbon nanotubes into bundled and individual nanotubes can be performed using any known technique that enables dispersion of individual nanotubes. For example combination of methods according to embodiments of the invention described herein can be combined with methods those commonly used in the art (i.e., centrifugation to remove bundled from individual nanotubes followed by an aggregating step). For example, as illustrated in FIG. 2A, following step (c) above (i.e., following method illustrated in FIG. 1), the bundled nanotubes are removed, with a remaining stable suspension being a mixture of individual (n,m) nanotube types. An additive induces certain (n,m) types of the individual nanotubes to aggregate into bundles. The bundles are then removed from the system at the interface of the two phase system using equivalent steps to (a)-(c) described above or using other separation methods, for example, that described in Ziegler, International Publication No. WO2008/057070. Alternatively, as illustrated in FIG. 2B, separating carbon nanotubes by size and/or (n,m) type can occur simultaneously with separation of carbon nanotubes into bundled and individual nanotubes in accordance with the methods described herein.

According to embodiments of the invention, SWNTs are dispersed in a surfactant solution via shear mixing, ultrasonication, or a combination thereof In some embodiments, the surfactant in the solution used for dispersion is capable of wrapping, encapsulating, or otherwise isolating the nanotubes into individual nanotubes.

In some embodiments, the surfactants for separating nanotube bundles from individual nanotubes can be ionic surfactants. Ionic surfactants can be anionic or cationic. Examples of anionic surfactants include, but are not limited to SARKOSYL® NL surfactants (SARKOSYL® is a registered trademark of Ciba-Geigy UK, Limited; other nomenclature for SARKOSYL NL surfactants include N-lauroylsarcosine sodium salt, N-dodecanoyl-N-methylglycine sodium salt and sodium N-dodecanoyl-N-methylglycinate), polystyrene sulfonate (PSS), sodium dodecyl sulfate (SDS), sodium dodecyl sulfonate (SDSA), sodium dodecylbenzenesulfonate (SDBS), sodium alkyl allyl sulfosuccinate (TREM) and combinations thereof. Examples of cationic surfactants that can be used, include, but are not limited to, dodecyltrimethylammonium bromide (DTAB), cetyltrimethylammonium bromide (CTAB), cetyltrimethylammonium chloride (CTAC) and combinations thereof.

Examples of nonionic surfactants that can be used to disperse nanotubes in a solvent include, but are not limited to, SARKOSYL® L surfactants (also known as N-lauroylsarcosine or N-dodecanoyl-N-methylglycine), BRIJ® surfactants (BRIJ® is a registered trademark of ICI Americas, Inc.; examples of BRIJ surfactants are polyethylene glycol dodecyl ether, polyethylene glycol lauryl ether, polyethylene glycol hexadecyl ether, polyethylene glycol stearyl ether, and polyethylene glycol oleyl ether), PLURONIC® surfactants (PLURONIC® is a registered trademark of BASF Corporation; PLURONIC surfactants are block copolymers of polyethylene and polypropylene glycol), TRITON®-X surfactants (TRITON® is a registered trademark formerly owned by Rohm and Haas Co., and now owned by Union Carbide; examples of TRITON-X surfactants include, but are not limited to, alkylaryl polyethether alcohols, ethoxylated propoxylated C₈-C₁₀ alcohols, t-octylphenoxypolyethoxyethanol, polyethylene glycol tert-octylphenyl ether, and polyoxyethylene isooctylcyclohexyl ether), TWEEN® surfactants (TWEEN® is a registered trademark of ICI Americas, Inc; TWEEN surfactants include, but are not limited to, polyethylene glycol sorbitan monolaurate (also known as polyoxyethylenesorbitan monolaurate), polyoxyethylene monostearate, polyoxyethylenesorbitan tristearate, polyoxyethylenesorbitan monooleate, polyoxyethylenesorbitan trioleate, and polyoxyethylenesorbitan monopalmitate), polyvinylpyrrolidone (PVP) and combinations thereof.

In some embodiments of the invention, to achieve separation of individual SWNTs from bundled SWNTs, the surfactant can be a non-ionic surfactant. Non-ionic surfactants that can be used to separate bundled SWNTs from individual SWNTs include, but are not limited to a polysacharide, Tween, Triton, Pluronics, Brij, DNA, and steroid-based surfactants. In one embodiment the surfactant in the solution is Gum Arabic.

In embodiments of the invention where separation of SWNTs that differ by size and/or type, an additive is included to induce aggregation of SWNTs. The additive can be any known salt including, but not limited to, LiF, LiCl, LiBr, LiI, LiNO₃, LiCH₃COO, Li₂SO₄, Li₂CO₃, NaF, NaCl, NaBr, NaI, NaNO₃, NaCH₃COO, Na₂SO₄, Na₂CO₃, KF, KCl, KBr, KI, KNO₃, KCH₃COO, K₂SO₄, K₂CO₃, RbF, RbCl, RbBr, RbI, RbNO₃, RbCH₃COO, Rb₂SO₄, Rb₂CO₃, CsF, CsCl, CsBr, CsI, CsNO₃, CsCH₃COO, Cs₂SO₄, Cs₂CO₃, MgF₂, MgCl₂, MgBr₂, MgI₂, Mg(NO₃)₂, Mg(CH₃COO)₂, MgSO₄, MgCO₃, CaF₂, CaCl₂, CaBr₂, CaI₂, Ca(NO₃)₂, Ca(CH₃COO)₂, CaSO₄, CaCO₃, and ErCl₃. In other embodiments, the additive is bromine. In other embodiments, the additive is a substance that induces a chemical reaction on the nanotube sidewall to encourage aggregation of SWNTs by type, such as those described in Ziegler, International publication number WO2008/057070.

Following dispersal of SWNTs into a surfactant solution, one or more solvents are provided to form a two-phase mixture. The solvents are immiscible with water, for example, an organic solvent. Organic solvents that can be used in accordance with the subject invention include, but are not limited to, heptane, hexane, chloroform, carbon tetrachloride, toluene, cyclohexane, benzene, and xylene.

The resulting two-phase mixture is agitated by either vigorous shaking of the vessel or a vortex mixer to yield an emulsion at the interface of the aqueous and organic solution-phases. The emulsion is stabilized by the bundled nanotubes.

In embodiments of the invention for separating SWNTs by type or by bundle, non-ionic and ionic surfactants, such as those described above, or mixtures thereof can be added to assist in the removal of SWNTs in suspension. Surfactants can be used that form micellular assemblies with SWNTs in an appropriate solvent medium. Mixtures of surfactants can be used that contain at least one surfactant capable of forming micellular assemblies with SWNTs in an appropriate solvent medium. Anionic, cationic or nonionic surfactants can be used in an appropriate solvent medium. Water can be used as a solvent medium.

Other surfactants that can be used in accordance with embodiments of the invention for aggregating SWNTs by size and/or type include, but are not limited to N-alkyl-amines such as N-alkyl-surfactant amine (e.g., octadecylamine (ODA)); primary, secondary, and tertiary amines with varying numbers of carbon atoms and functionalities in their surfactant alkyl chains (e.g., butyl-, sec-butyl-, tert-butyl-, pentyl-, hexyl-, heptyl-, octyl-, nonyl-, decyl-, dodecyl-, tetradecyl-, hexadecyl-, eicosadecyl-, tetracontyl-, pentacontyl-amines, 10,12-pentacosadiynoylamine, 5,7-eicosadiynoylamine, and combinations comprising one or more of the foregoing amines); and alkyl-aryl amines (e.g., benzyl amine, aniline, phenethyl amine, N-methylaniline, N,N-dimethylaniline, 2-amino-styrene, 4-pentylaniline, 4-dodecylaniline, 4-tetradecylaniline, 4-pentacosylaniline, 4-tetracontylaniline, 4-pentacontylaniline, and combinations comprising one or more of the foregoing amines).

In some embodiments of the invention, when separating SWNTs by type or by bundle, a second solvent can be added to assist in the removal of SWNTs in suspension. Solvents that can be used include, but are not limited to, heptane, hexane, chloroform, ethyl acetate, methylene chloride, tetrahydrofuran, diethyl ether, carbon tetrachloride, toluene, cyclohexane, benzene, and xylene.

In some embodiments of the invention, when separating SWNTs by type or by bundle, the nanotubes can be initially dispersed in an organic surfactant solution rather than an aqueous phase. In these embodiments, an aqueous phase would be added to the organic surfactant solution to form a two-phase mixture followed by agitating the two-phase mixture to form an emulsion at the interface between the two-phase mixture.

Depending on the volume ratios of the surfactant/solvent solutions, the emulsions produced following agitation of the two-phase mixture are either droplets of water in a continuous oil phase (i.e. water-in-oil (w/o) emulsions) or oil-in-water (o/w) emulsions. For example, a high volume ratios of toluene/water yield water-in-oil (w/o) emulsions results in a high concentration of dispersed individual nanotubes in suspension. However, the fraction of individual to bundled SWNTs in the suspension-phase is very high in oil-in-water (o/w) emulsions.

Because aqueous single-walled carbon nanotube suspensions exhibit strong fluorescence, indicative of a population of suspended individual nanotubes, fluorescence spectra in combination with absorbance spectra can be used to assess whether the separation method should be repeated to further extract bundled carbon nanotubes remaining in solution.

The following examples illustrate procedures for practicing embodiments of the invention. These examples should not be construed as limiting. All percentages are by weight and all solvent mixture proportions are by volume unless otherwise noted.

### Example 1

Nanotube suspensions were prepared with a given mass (typically 6 mg) of raw SWNTs (Rice HPR 145.1) and mixed with 200 mL of an aqueous Gum Arabic surfactant solution (1 wt. %) by high-shear homogenization (IKA T-25 Ultra-Turrax) for 1 hour and ultrasonication (Misonix S3000) for 10 minutes according to previous reported preparations. This yields a solution containing individual nanotubes surrounded by surfactant as well as nanotube bundles. Toluene was added to the aqueous SWNT suspension and the mixture was shaken vigorously for 30 seconds to increase interfacial area and trap SWNT bundles at the interface.

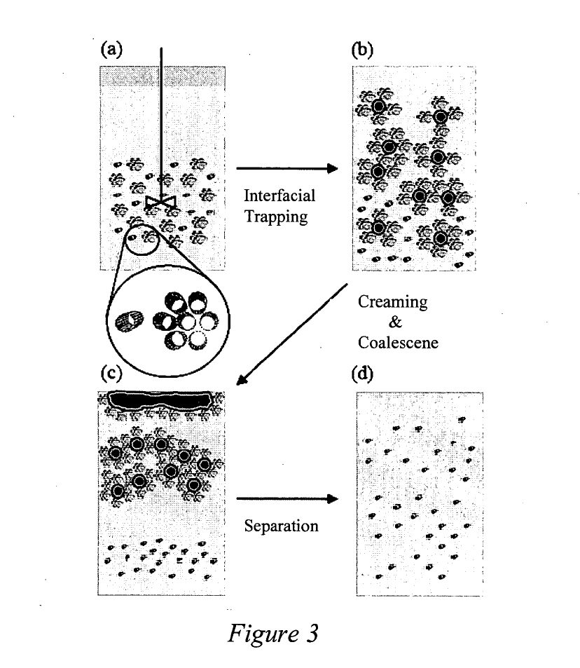

FIG. 3 shows the overall two-phase interfacial trapping process. First, nanotubes are homogenized and ultrasonicated in a surfactant solution resulting in a suspension that contains both individually dispersed and bundled SWNTs. An immiscible organic solvent is added (FIG. 3(a)) to the aqueous suspension forming a two-phase system. This two-phase system is then mixed, resulting in either o/w or w/o emulsions depending on the volume ratios. SWNT bundles preferentially adsorb at the emulsion interface when mixed (FIG. 3(b)). The emulsions then “cream” and coalesce into a continuous phase after mixing, with some emulsions being stabilized by the SWNT bundles (FIG. 3(c)). Finally, phase separation into an organic phase, an interphase of stabilized emulsions, and a transparent aqueous phase allows easy collection of the individually suspended SWNTs. SWNT bundles can be removed from bulk fluids (FIG. 3(d)).

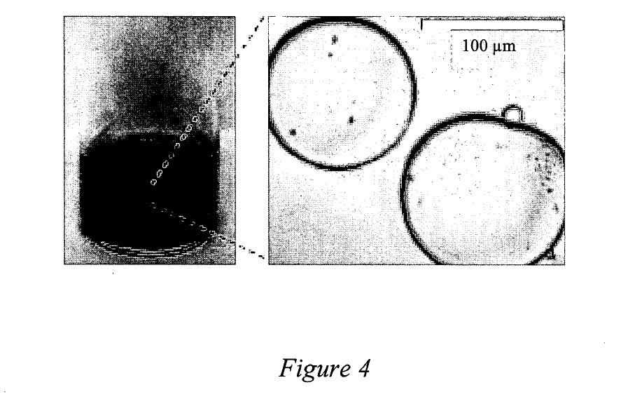

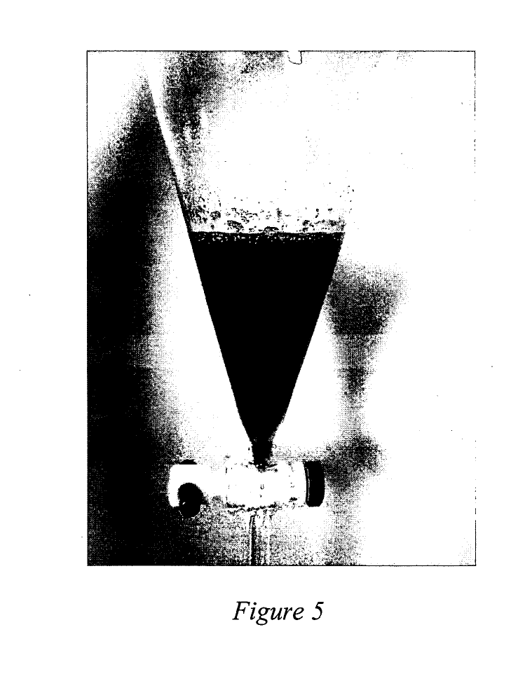

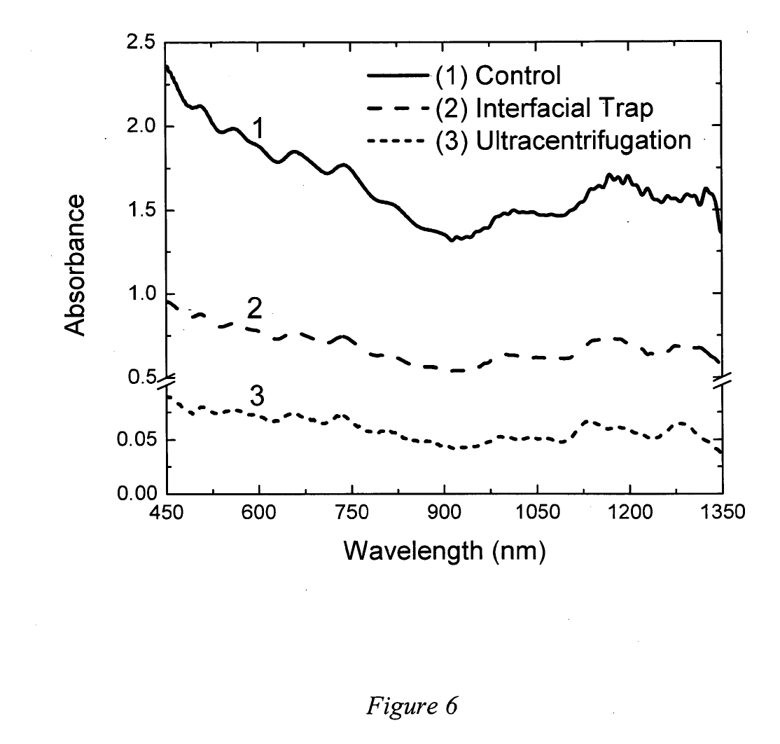

FIG. 4 and FIG. 5 represent typical examples of the system after phase separation with interfacial trapping. As can be seen in the separatory vial, FIG. 4, or separatory funnel, FIG. 5, a stable interphase is formed with a lower aqueous phase, which can occur less than 1 mm after mixing. No nanotubes are observed in the organic phase. The optical micrograph in FIG. 4 confirms emulsion stabilization with diameters of approximately 100 μm. The optical micrograph represents toluene/water emulsions stabilized by SWNTs at Vₜₒₗᵤₑₙₑ/V_{aqueous}=0.1. The initial mass of SWNTs is 6 mg.

Vis-NIR absorbance spectra (Applied NanoFluorescence Nanospectrolyzer) are shown in FIG. 5. The solutions were allowed to settle for at least 60 min to ensure that steady state was achieved. The homogenized and sonicated sample (control) has high absorbance due to the concentration of both individual (as evidenced by the van Hove singularities) and bundled SWNTs. The absorbance of the suspension has clearly decreased after interfacial trapping demonstrating removal of nanotubes from the aqueous phase. When the control suspension was centrifuged, the absorbance of the aqueous phase is significantly lower, demonstrating nearly complete removal of nanotubes upon centrifugation.

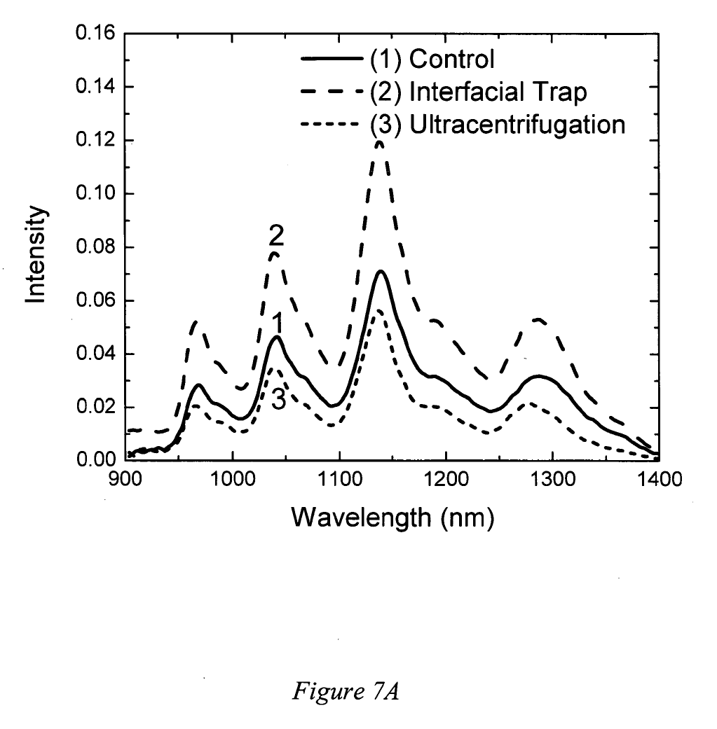

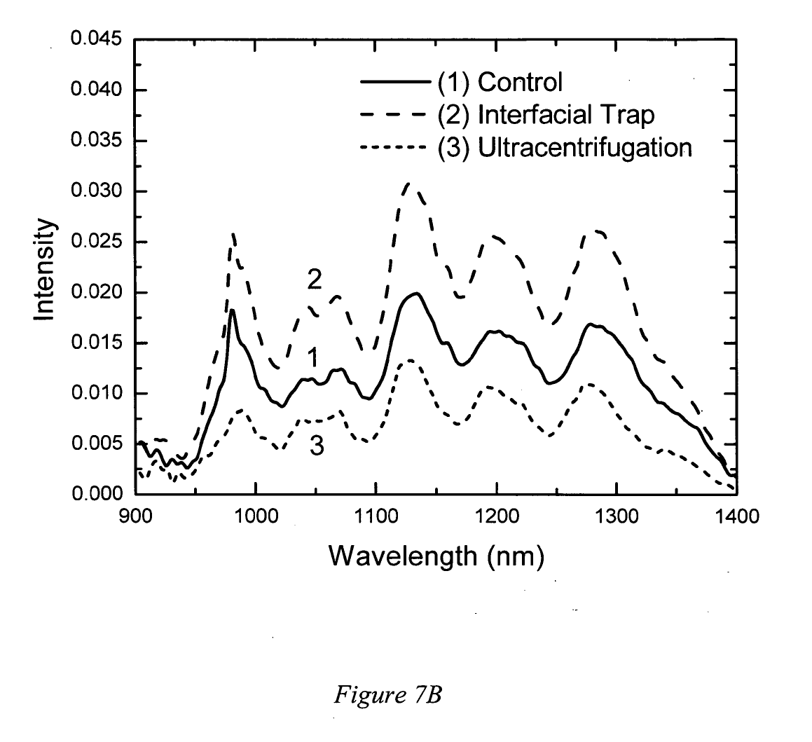

Fluorescence spectra provide a sensitive probe to the aggregation state of the aqueous phase. Higher intensity peaks in the spectra indicate improved dispersion since metallic nanotubes inside a bundle interrupts the electronic excitation of adjacent semiconducting nanotubes within the bundle. Fluorescence spectra of the aqueous phase were recorded (Applied NanoFluorescence Nanospectrolyzer) after steady state was achieved (30-60 min) as shown in FIGS. 7(a) and 7(b) with excitation at 660 nm and 785 nm, respectively. For comparison, the spectra after homogenization and ultrasonication is shown (control sample) as well as the spectra using conventional ultracentrifugation rather than interfacial trapping. The spectra show that centrifugation results in a substantial decrease in fluorescence intensity indicative of the removal of individual nanotubes. However, the fluorescence intensity after interfacial trapping increased compared to the control sample. In highly concentrated suspensions such as the control sample, the intertube spacing is expected to be small because of the high volume fraction of nanotubes, both individual and bundled.

Typically, bundled nanotubes do not exhibit fluorescence because of the presence of metallic SWNTs. Additionally the fluorescence intensity of individually suspended SWNTs decay as the volume fraction increases because of energy-transfer self-quenching mechanisms. Selective removal of SWNT bundles from the solution would allow more individual, semiconducting SWNTs to be excited and result in increased fluorescence intensities. Therefore, the fluorescence intensity increases seen in FIG. 7 after interfacial trapping are attributed to the selective removal of SWNT bundles.

### Example 2

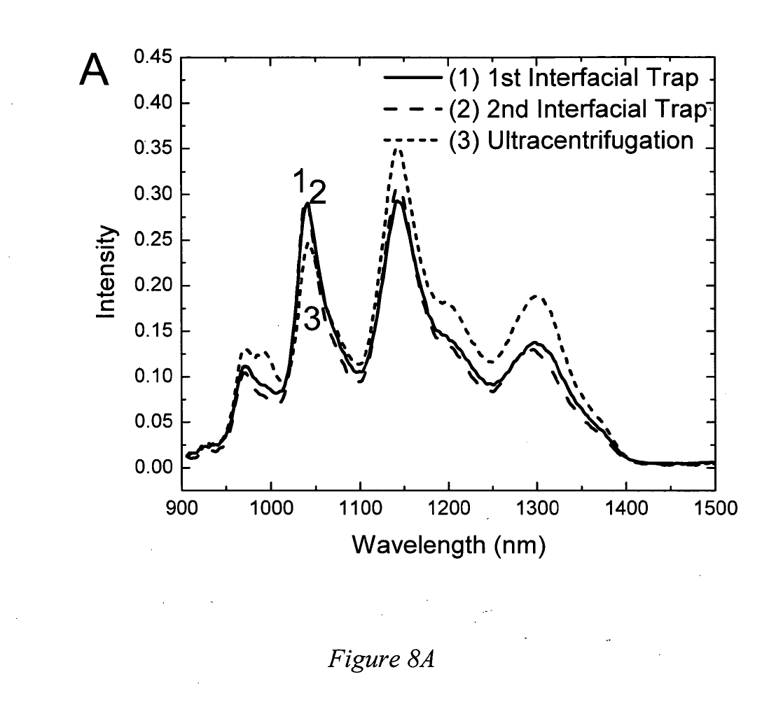

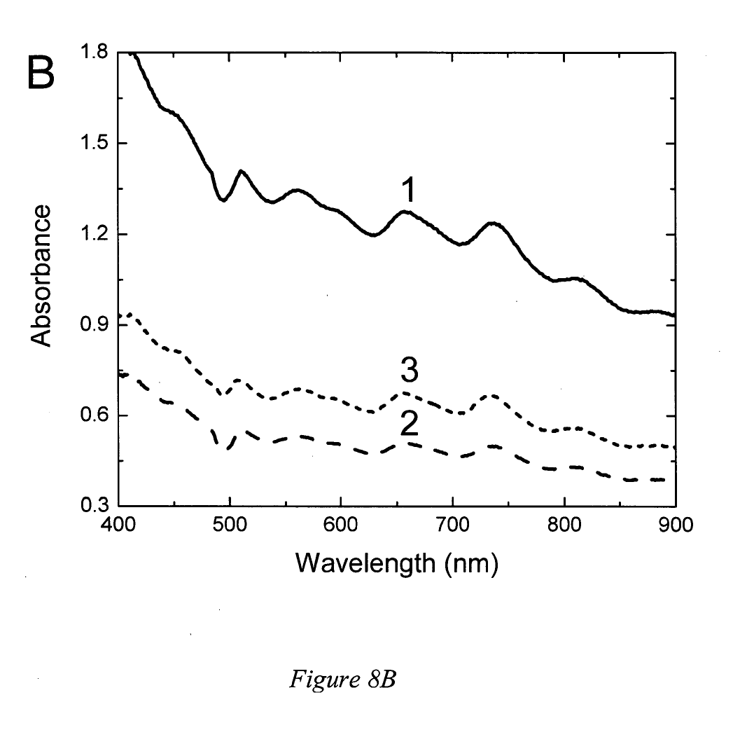

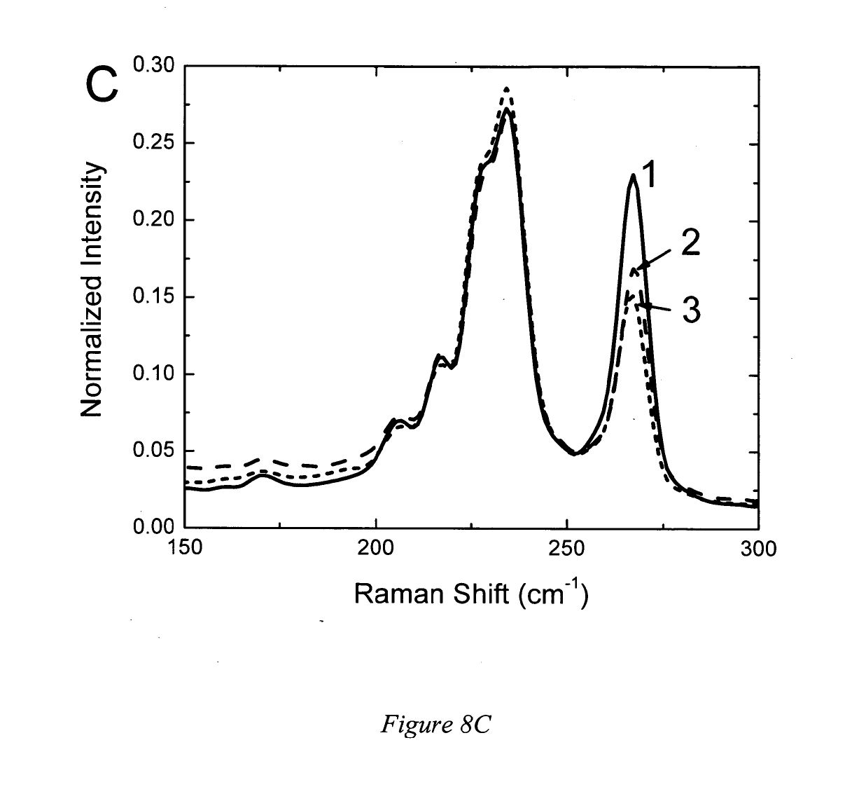

To further improve the quality of the suspensions, a second interfacial trapping step is introduced. The SWNT suspension was first mixed with toluene at a volume ratio of R=0.1 since o/w emulsions were the most effective at removing bundled nanotubes from the aqueous phase. The aqueous phase was separated from the oil and interphase and then mixed again with toluene at a volume ratio of R=0.1. As seen in FIG. 8(a), the second interfacial trap has little effect on the fluorescence intensity. However, the absorbance spectrum shown in FIG. 8(b) has decreased significantly, resulting in significant changes to the fraction of bundled SWNTs. The Raman aggregation peak has also shown further improvement after the second interfacial trapping step as shown in FIG. 8(c). It is important to note that changes to both Raman and absorbance spectra without changes to the fluorescence provide strong evidence that the interfacial trapping process is highly selective in the removal of bundled SWNTs from the aqueous phase. Table 1, below, summarizes the dispersion quality measurements for the two-step interfacial process compared to ultracentrifugation. As seen in the table, interfacial trapping shows better dispersion than ultracentrifugation by the F/A ratio and comparable dispersion quality when characterized by Raman and absorbance spectra.

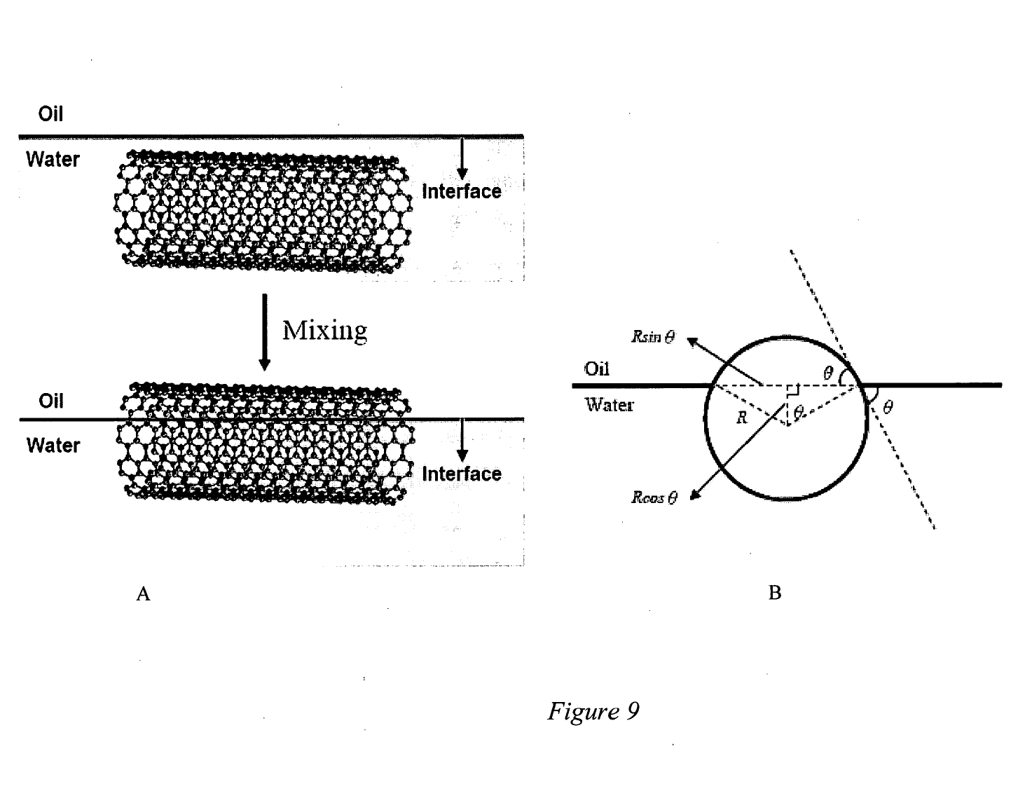

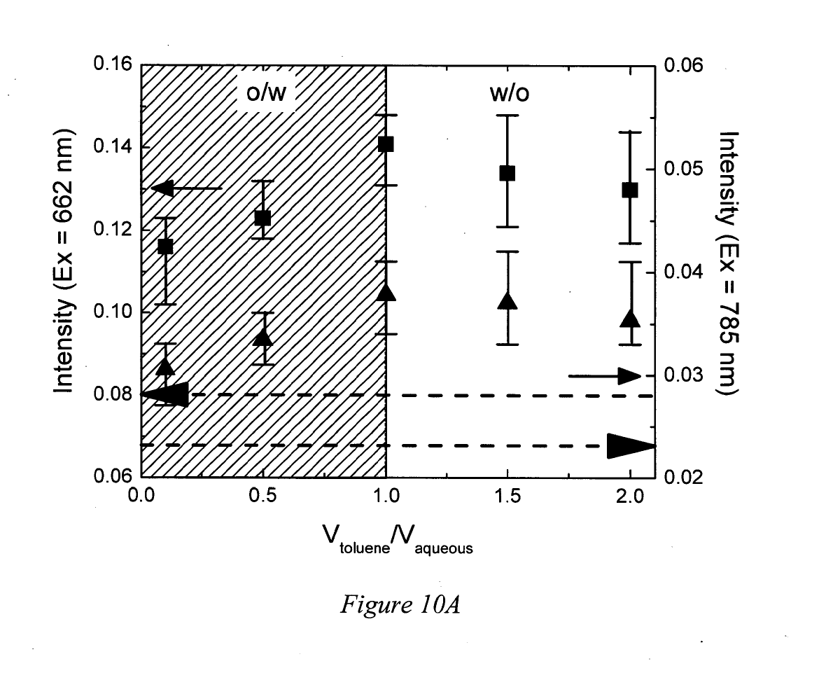

Without being bound to any specific theory, this example describes the preferential trapping of SWNT bundles at the interface via minimization of free energy. FIG. 9(a) shows a schematic for the process of an individual SWNT or nanotube bundle being trapped at the interface. Initially, the nanotubes are dispersed in the aqueous phase and upon mixing they are transferred to the oil-water interface. FIG. 9(b) represents the end of a nanotube trapped at the interface having radius R and a contact angle θ measured into the aqueous phase.

TABLE 1
Dispersion quality comparison of aqueous SWNT suspensions.

| | Aqueous Suspension | | | |
|---|---|---|---|---|
| | | Interfacial | | Two-step Interfacial |
| Analysis | Control | Trapping | Ultracentrifugation | Trapping |
| Fluorescence | weak | strong | strong | strong |
| intensity | | | | |
| Absorbance | broad peaks | blue-shifted and | blue-shifted and | blue-shifted and |
| features | | resolved peaks | resolved peaks | resolved peaks |
| Resonant | 0.0118 | 0.0397 | 0.0486 | 0.0406 |
| Ratio¹ | | | | |
| Diameter | 12.8 ± 11.9 nm | 4.1 ± 3.7 nm | — | — |
| distribution² | | | | |
| Raman | 0.7265 | 1.1868 | 1.8860 | 1.5952 |
| aggregation ratio³ | | | | |
| F/A Ratio⁴ | 0.0135 | 0.2300 | 0.5234 | 0.6077 |

¹Calculation based on peak near 660 nm
²Distribution determined from AFM and SIMAGIS image analysis
³Calculation based on intensity from (11, 3) nanotubes and aggregation peak (~270 cm⁻¹)
⁴Calculation based on fluorescence intensity from (7, 6) nanotubes and absorbance at 662 nm

For this example, for a cylindrical particle of radius (R) and length (L) with parallel orientation to the interface, the reduction in interfacial area between the oil and water phases is given by:

ΔA_{ow}=(2R sin θ)L (1)

If the interface is assumed to be planar and the weight of the nanotube is ignored, the change in energy of inserting the SWNT at the interface from the bulk aqueous phase is given by:

$$Δ E = 2 π RL ( \frac{2 θ}{{360}^{°}} ) ( {γ}_{po} - {γ}_{pw} ) - 2 RL {γ}_{ow} sin θ \qquad ( 2 )$$

where γₚₒ, γ_{pw}, and γ_{ow} are the interfacial tensions at the particle-oil, particle-water, and oil-water interface, respectively. If ΔE is negative, the particle will be in a stable position at the interface. The interfacial tensions are related to the contact angle through Young's equation:

γₚₒ−γ_{pw}=γ_{ow} cos θ (3)

Finally, the change in energy for inserting a single nanotube or bundle at the oil-water interface is given by:

$$Δ E = 2 RL {γ}_{ow} [ \frac{πθ}{{180}^{°}} cos θ - sin θ ] \qquad ( 4 )$$

The contact angle will be similar for individual nanotubes and bundles because of their similar hydrophilicity and γ_{ow} is fixed in the system. Therefore, in aqueous SWNT suspensions the change in energy of inserting a particle at the interface depends on R and L. The change in energy from equation (4) is minimized when particles with larger radius and length are at the interface. For example, it is estimated that ΔE is approximately −200 kT for an individual nanotube and −4500 kT for a bundle of the same length containing 7-10 nanotubes. Short length multi-walled nanotubes display lower emulsion stabilities. Therefore, SWNT bundles will preferentially exist at the interface yielding an effective separation.

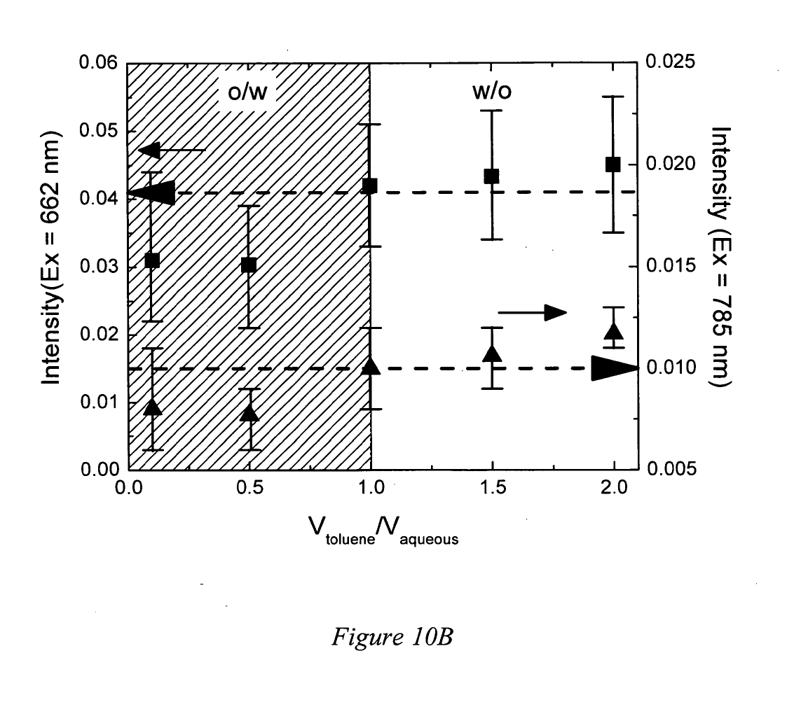

FIG. 10 shows the variation of fluorescence emission intensity of the most intense peak in the spectra (λ=1140 nm) as a function of the volume ratio of toluene to the aqueous SWNT suspension (Vₜₒₗᵤₑₙₑ/V_{aqueous}). The sample was prepared from (a) 6 mg or (b) 1 mg raw SWNTs. Excitation at 660 nm (▪) and 785 nm (▴). As seen in FIG. 10(a) for an initial SWNT mass of 6 mg, higher fluorescence intensity is observed for Vₜₒₗᵤₑₙₑ/V_{aqueous}=1. The higher conductivity of the solution at ratios greater than 1 suggests w/o emulsions while o/w emulsions are seen for ratios less than 1. It is also seen that the fluorescence intensity is always greater than the control (dashed lines in FIGS. 10(a) and 10(b)) for initial mass loadings of 6 mg. As can be see in FIG. 10(b), the emission intensity is lower than the control for o/w emulsions while w/o emulsions (Vₜₒₗᵤₑₙₑ/V_{aqueous}=1) show relatively constant intensity. The same trends are seen for other emission peaks and other mass loadings.

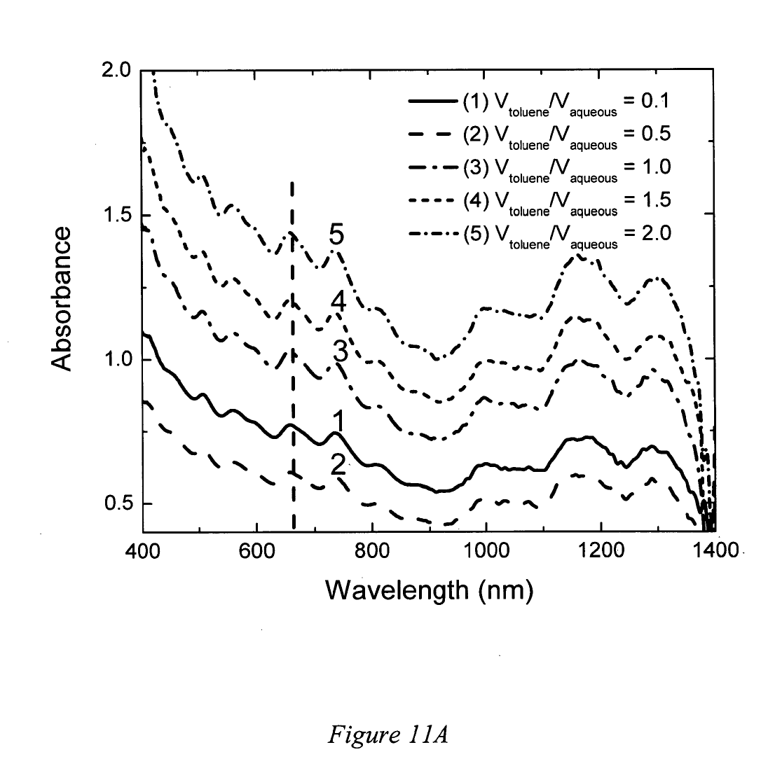

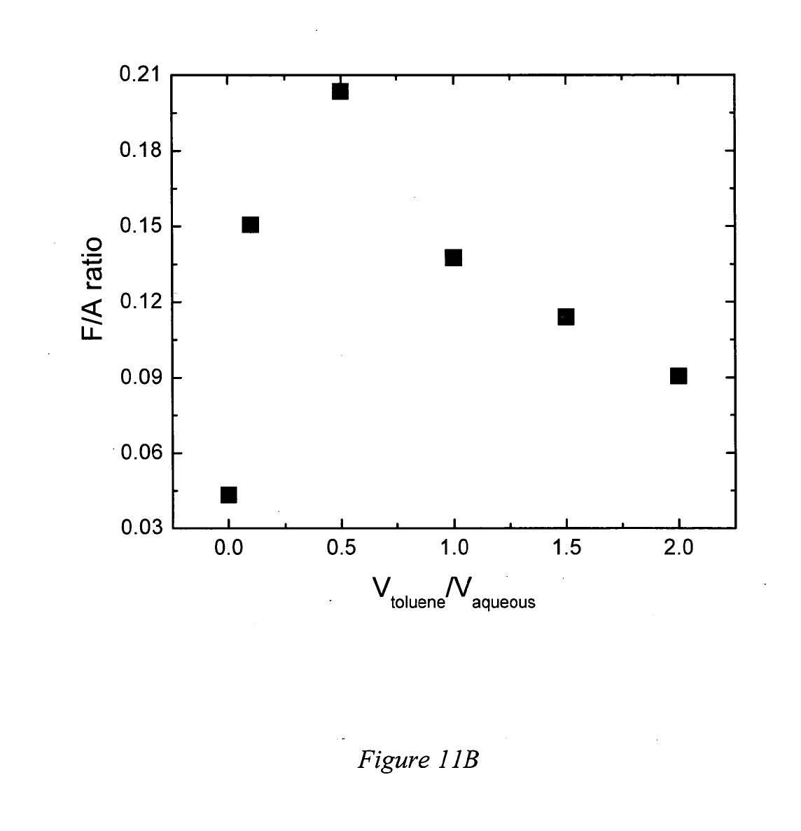

Absorbance spectra are shown in FIG. 11(a) for multiple ratios of Vₜₒₗᵤₑₙₑ/V_{aqueous} (baseline corrected at 920 nm). The absorbance for the control sample is not shown due to the high absorbance and noise associated with this concentrated solution. The van Hove singularities are noticed for all aqueous solutions and clearly the absorbance has decreased significantly after the interfacial traps. The lowest absorption intensities are seen for o/w systems.

The fluorescence and absorbance data provide insight into the structure of the aqueous phase and the changes induced by the interfaces. Fluorescence intensities greater than the control sample at higher mass loadings seen in FIG. 10(a) indicate that nanotube bundles have been preferentially removed from the aqueous phase at all volume ratios. The higher intensities observed for w/o systems could be due to higher concentrations of individual nanotubes or the decrease of bundled SWNTs when compared with the o/w systems. Lowering the initial mass loading of nanotubes (i.e. concentration) reduces the intertube spacing minimizing the effect that bundles have on the fluorescence intensity. At mass loadings of 1 mg shown in FIG. 7(b), it is seen the presence of bundles has little effect on the fluorescence spectra because the intensity remains relatively constant even though the absorbance has diminished significantly. The slight decrease in emission intensity for o/w systems suggests the removal of individual SWNTs from the aqueous phase while the absorbance confirms the removal of bundles. On the other hand, w/o systems show substantial decreases in absorbance and no decrease in fluorescence emission indicating a higher concentration of individually suspended SWNTs. The absorption spectra are also higher than that observed for o/w systems indicating a higher concentration of bundles. This data suggests that w/o systems have a weaker ability to remove both individual and bundled SWNTs with a preferential adsorption of bundles to the interface.

Adjusting the hydrophilicity of the particles had significant effects on the contact angle and their ability to stabilize the emulsions. Individual and bundled nanotubes are coated with hydrophilic surfactants provide higher stabilization of o/w emulsions. Therefore, while bundles have a greater change in free energy there is still a substantial driving force for individual nanotubes to stabilize o/w emulsions. In contrast, individual nanotubes have a smaller driving force to w/o interfaces with nanotube bundles being the primary constituent of the interface. This suggests that the system contains a small fraction of uncoated (hydrophobic) or poorly coated nanotube bundles that stabilize w/o emulsions.

The fluorescence intensity provides a measure of the concentration of individually suspended SWNTs while the absorbance provides a measure of the overall concentration of SWNTs. Dividing the fluorescence by the absorption, therefore, provides an estimate of the fraction of individual SWNTs in suspension. This ratio does not provide a quantitative measure of the fraction of individual SWNTs. Therefore, it is only used to compare dispersion characteristics between samples. FIG. 11(b) plots the fluorescence to absorbance (F/A) ratio as a function of the toluene/water volume ratio. Higher F/A ratios are seen for o/w systems when compared to w/o systems indicating that a higher fraction of individual nanotubes are suspended in o/w systems via interfacial trapping.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

We claim:

1. A method for separating carbon nanotube bundles from individual carbon nanotubes comprising the steps of:
dispersing a mixture of individual and bundled carbon nanotubes in a solution comprising at least one surfactant to form a suspension;
adding at least one solvent to the suspension to form a two-phase mixture;
agitating the two-phase mixture to form an emulsion interface between a suspension-phase and a solution-phase, wherein nanotube bundles are preferentially absorbed at the emulsion interface; and
isolating the suspension-phase wherein the suspension-phase comprises individual carbon-nanotubes.

2. The method of claim 1, wherein the individual and bundled carbon nanotubes comprise single-walled carbon nanotubes.

3. The method of claim 1, wherein the surfactant comprises an anionic surfactant, cationic surfactant, non-ionic surfactant or any combination thereof.

4. The method of claim 1, wherein the solution comprises an aqueous solution and the solvent comprises an organic solvent.

5. The method of claim 4, wherein the organic solvent is selected from the group consisting of: heptane, hexane, chloroform, carbon tetrachloride, toluene, cyclohexane, benzene, and xylene.

6. The method of claim 1, wherein the solution comprises a non-aqueous solution and the solvent comprises water.

7. The method of claim 1, further comprising the step of performing fluorescence and absorbance spectroscopy of the suspension-phase to assess the composition of the individual and the bundled carbon nanotubes in the suspension-phase.

8. The method of claim 1, further comprising the steps of:
combining at least one second solvent with the isolated suspension-phase to form a second two-phase mixture;
agitating the second two-phase mixture to form a second emulsion interface between a second suspension-phase and a second solution-phase, wherein nanotube bundles are preferentially absorbed at the second emulsion interface; and
isolating the second suspension-phase wherein the second suspension-phase comprises individual carbon-nanotubes, wherein the steps of combining, agitating and isolating can be repeated one or more times, wherein the isolated second suspension-phase is used as the isolated suspension-phase in the repeated combining step.

9. The method of claim 1, further comprising the steps of:
mixing at least one additive to the isolated suspension-phase, wherein aggregation of a portion of the individual nanotubes into a second mixture of second individual and second bundled carbon nanotubes to form a second resultant suspension, wherein the second bundled carbon nanotubes are of a selected size and/or type;
combining at least one second solvent with the second resultant suspension to form a second two-phase mixture;
agitating the second two-phase mixture to form a second emulsion interface between a second suspension-phase and a second solution-phase, wherein the second bundled carbon nanotubes are preferentially absorbed at the second emulsion interface; and
isolating the second suspension-phase wherein the second suspension-phase comprises individual carbon-nanotubes have a size and/or type different than the second bundled carbon nanotubes.

10. The method of claim 9, wherein the additive is selected from the group consisting of LiF, LiCl, LiBr, LiI, LiNO₃, LiCH₃COO, Li₂SO₄, Li₂CO₃, NaF, NaCl, NaBr, NaI, NaNO₃, NaCH₃COO, Na₂SO₄, Na₂CO₃, KF, KCl, KBr, KI, KNO₃, KCH₃COO, K₂SO₄, K₂CO₃, RbF, RbCl, RbBr, RbI, RbNO₃, RbCH₃COO, Rb₂SO₄, Rb₂CO₃, CsF, CsCl, CsBr, CsI, CsNO₃, CsCH₃COO, Cs₂SO₄, Cs₂CO₃, MgF₂, MgCl₂, MgBr₂, MgI₂, Mg(NO₃)₂, Mg(CH₃COO)₂, MgSO₄, MgCO₃, CaF₂, CaCl₂, CaBr₂, CaI₂, Ca(NO₃)₂, Ca(CH₃COO)₂, CaSO₄, CaCO₃, and ErCl₃.

11. The method of claim 9, wherein the additive consists of bromine

12. A method for separating individual carbon nanotubes of different sizes and/or types comprising the steps of:
dispersing a mixture of individual carbon nanotubes in a solution comprising at least one surfactant to form a suspension;
mixing at least one additive to the suspension to form a second suspension wherein a portion of the individual carbon nanotubes of a selected size and/or type aggregate into bundled carbon nanotubes to form a second suspension;
adding at least one solvent to the second suspension to form a two-phase mixture;
agitating the two-phase mixture to form an emulsion interface between a suspension-phase and a solution-phase, wherein nanotube bundles are preferentially absorbed at the emulsion interface; and
isolating the suspension-phase wherein the suspension-phase comprises individual carbon-nanotubes enriched in a size and/or type different from that of the bundled carbon nanotubes.

13. The method of claim 12, wherein the surfactant is selected from the group consisting of SDS, SDBS, sodium cholate, polysaccharide, Tween, Triton, Pluronics, Brij, DNA, steroid-based surfactants, alkylamines and porphyrin.

14. The method of claim 12, wherein the additive is selected from the group consisting of LiF, LiCl, LiBr, LiI, LiNO₃, LiCH₃COO, Li₂SO₄, Li₂CO₃, NaF, NaCl, NaBr, NaI, NaNO₃, NaCH₃COO, Na₂SO₄, Na₂CO₃, KF, KCl, KBr, KI, KNO₃, KCH₃COO, K₂SO₄, K₂CO₃, RbF, RbCl, RbBr, RbI, RbNO₃, RbCH₃COO, Rb₂SO₄, Rb₂CO₃, CsF, CsCl, CsBr, CsI, CsNO₃, CsCH₃COO, Cs₂SO₄, Cs₂CO₃, MgF₂, MgCl₂, MgBr₂, MgI₂, Mg(NO₃)₂, Mg(CH₃COO)₂, MgSO₄, MgCO₃, CaF₂, CaCl₂, CaBr₂, CaI₂, Ca(NO₃)₂, Ca(CH₃COO)₂, CaSO₄, CaCO₃, and ErCl₃.

15. The method of claim 12, wherein the additive consists of bromine.

16. The method of claim 12, wherein the additive consists of an alkylamine or a porphyrin.

17. The method of claim 12, further comprising the step of performing fluorescence and absorbance spectroscopy of the suspension-phase to assess the composition of the individual and the bundled carbon nanotubes in the suspension-phase.

18. The method of claim 12, further comprising the steps of:
combining at least one second solvent with the isolated suspension-phase to form a second two-phase mixture;
agitating the second two-phase mixture to form a second emulsion interface between a second suspension-phase and a second solution-phase, wherein nanotube bundles are preferentially absorbed at the second emulsion interface; and
isolating the second suspension-phase wherein the second suspension-phase comprises individual carbon-nanotubes, wherein the steps of combining, agitating and isolating can be repeated one or more times, wherein the isolated second suspension-phase is used as the isolated suspension-phase in the repeated combining step.
